(19) United States
(12) Patent Application Publication
(10) Pub. No.: US 2015/0265970 A1
(43) Pub. Date: Sep. 24, 2015

(54) AMMONIA ABATEMENT SYSTEM FOR EXHAUST SYSTEMS

(71) Applicants: Bradley Jay Adelman, Chicago, IL (US); Shyam Santhanam, Aurora, IL (US)

(72) Inventors: Bradley Jay Adelman, Chicago, IL (US); Shyam Santhanam, Aurora, IL (US)

(73) Assignee: International Engine Intellectual Property Company, LLC, Lisle, IL (US)

(21) Appl. No.: 14/410,798

(22) PCT Filed: Jun. 28, 2012
(86) PCT No.: PCT/US12/44546

§ 371 Date: Dec. 23, 2014

(51) Int. Cl. B01D 53/94

(52) U.S. Cl. CPC B01D 53/9436; B01D 53/9454; B01D 53/9477; B01D 2255/1021; B01D 2255/1023; B01D 2255/50

(57) ABSTRACT

An ammonia abatement system and method for an exhaust system that includes a threeway catalytic converter (TWC) and a diesel particulate filter (DPF). Exhaust gas entering the TWC above the stoichiometric point (>1) may result in the formation of elevated levels of ammonia in the exhaust gas. To prevent the increased quantities of ammonia from skipping through the DPF, the DPF includes a catalyst to oxidize some of the ammonia and an acidic material to adsorb and store at least a portion of the excess ammonia. The acidic material may also release at least some of the adsorbed ammonia when a lean exhaust gas is present in the DPF. Additionally, an additive, such as copper or iron, may be added to the acidic material that may convert some of the NOx in the lean exhaust gas into nitrogen gas (or nitrous oxide) and water.

### BACKGROUND

Combustion engines may employ emission controls or systems that are configured to reduce the amount of nitrogen oxides (NOx), such as nitrogen dioxide, present in the engine's exhaust gas. One type of emission control used by internal combustion engines that combust fossil fuels, such as diesel fuel, gasoline, and petroleum, is a three-way catalytic converter (TWC). A TWC may include a housing that contains reduction catalysts and oxidation catalysts. These catalyst formulations may be used for the reduction of NOx to nitrogen (or nitrous oxide) and carbon dioxide or water; oxidation of carbon monoxide to carbon dioxide; and, oxidation of un-burnt hydrocarbons to carbon dioxide and water. However, exhaust gases exiting the TWC may still include NOx as well as ammonia (NH₃), the product of over-reduction of NOx.

The amount of NH₃ in the exhaust gas exiting the TWC may be related to the condition of the exhaust gas when the exhaust gas was delivered to the TWC. Moreover, exhaust gases may enter the TWC below, at, or above the stoichiometric point. For example, when an engine is being operated to accelerate the speed of the associated vehicle, the exhaust gas entering the TWC may be rich, wherein the exhaust gas is above the stoichiometric point (>1). However, with some TWC catalyst formulations, the supply of exhaust gases that are above the stoichiometric point (>1) may result in the formation of relatively high levels, or spikes, of several hundreds of ppm of NH₃ in the exhaust gas. Conversely, exhaust gas may be in a lean condition when the exhaust gas entering the TWC is not above the stoichiometric point, in which event the exhaust gas exiting the TWC may not have elevated or spiked levels of NH₃ and there is limited or no NOx reduction.

Emission control systems may also include a particulate filter that is positioned downstream of the TWC that may further remove NH₃ from the exhaust gas, as well as other contaminants. For example, diesel engines may include a diesel particulate filter (DPF) that may be configured to remove particulate matter, such as soot, from the exhaust gas that has exited the TWC. Further, the DPF may be configured to oxidize NH₃ in the exhaust gas to form nitrogen (or nitrous oxide) gas and water. For example, some DPFs may include a coating having platinum (Pt) and/or palladium (Pd) and alumina (Al₂O₃) that act as a catalyst to oxidize NH₃ in the exhaust gas that is present in the DPF.

Yet, DPFs are not always able to oxidized adequate amounts of NH₃ in the DPF when the quantity of NH₃ in the exhaust gas is elevated or spikes. Yet, as previously discussed, such spikes in NH₃ levels in the DPF may occur during periods of engine operation in which the exhaust gas delivered to the TWC is rich, or above the stoichiometric point (>1). In such situations, rather than being oxidized in the DPF, an undesirable amount of NH₃ may be able to pass, untreated, through the DPF and toward the vehicle's tailpipe.

### SUMMARY

Embodiments depicted herein related a DPF for use in an exhaust gas treatment system. The DPF includes a catalyst that is configured to oxidize at least a portion of ammonia in an exhaust gas that is present in the DPF to form nitrogen (or nitrous oxide) gas and water. The DPF may also include an acidic material that is configured to adsorb and store at least a portion of the ammonia from the exhaust gas that is present in the diesel particulate filter.

According to another embodiment, the DPF includes a catalyst that is configured to oxidize at least a portion of the ammonia in a rich exhaust gas that is present in the diesel particulate filter to form nitrogen (or nitrous oxide) gas and water. The DPF also includes an acidic material that is configured to adsorb and store at least a portion of the ammonia from the rich exhaust gas that is present in the diesel particulate filter. Additionally, the acidic material may be further configured to release at least a portion of the adsorbed ammonia from the acidic material when a lean exhaust as is present in the diesel particulate filter.

Another aspect of the illustrated embodiment is a method for the abatement of ammonia for a diesel engine exhaust system having a TWC and a DPF. The method includes delivering a first exhaust gas from a combustion chamber of an internal combustion engine to the housing of the TWC, the first exhaust gas being above the stoichiometric point (>1). The method also includes converting, in the TWC, nitrogen oxides in the first exhaust gas to nitrogen (or nitrous oxide) gas and oxygen to from a second exhaust gas, with the conversion of the nitrogen oxides producing an elevated amount of ammonia in the outlet exhaust second exhaust gas. The method further includes delivering the second exhaust gas to the DPF. At least a portion of the ammonia in the second exhaust gas is oxidized in the DPF using an oxygen gas and a catalyst having at least one platinum group metal and alumina. The method further includes adsorbing, in an acidic material in the DPF, at least a portion of the ammonia in the second exhaust gas that has not been oxidized. According to certain embodiments, the method further includes the steps of releasing, from the acidic material, at least a portion of the adsorbed ammonia, and oxidizing, in the diesel particulate filter, at least a portion of the released ammonia. Additionally, the method may also include the step of converting, in the diesel particulate filter, NOx in an exhaust gas using a metal exchanged additive of the acidic material and ammonia that was adsorbed by the acidic material.

### BRIEF DESCRIPTION OF THE DRAWINGS

FIG. 1 is a function block diagram of an engine system that includes an exhaust gas treatment system.

FIG. 2 illustrates a cross sectional view of a portion of a DPF that has a first surface that has been washcoated to provide a Pt and/or Pd and alumina catalyst and an acidic material that adsorbs NH₃, which is stored as NH₄⁺.

FIG. 3 illustrates a cross sectional view of a portion of the DPF shown in FIG. 2 with the NH₃ that was adsorbed and stored by the acidic material as NH₄⁺ having been released as NH₃+H⁺ (which is retained at the acidic site), and which is oxidized by the Pt/Pd catalyst to form nitrogen (or nitrous oxide) gas and water.

FIG. 4 illustrates a cross sectional view of the DPF of FIG. 2 with the acidic material being zeolite that includes a copper or iron additive that is used for the conversion of NOx into nitrogen (or nitrous oxide) gas and water.

### DETAILED DESCRIPTION

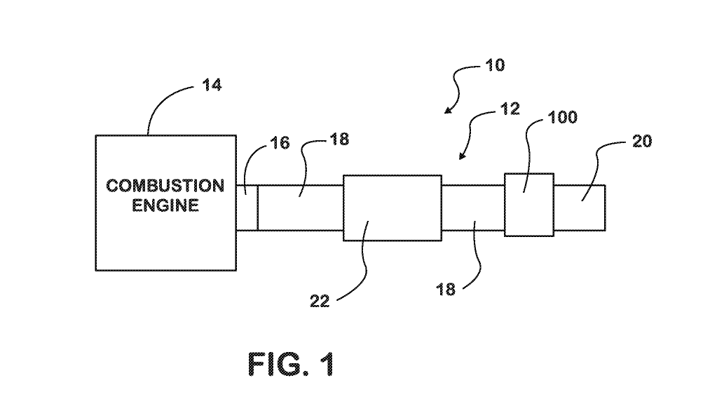

FIG. 1 is a function block diagram of an engine system 10 that includes an exhaust gas treatment system 12. As shown, the engine system 10 includes a combustion engine 14, such as, for example, and an internal combustion engine that combusts diesel fuel, gasoline, or petroleum. The engine system 10 may also include an exhaust manifold 16 that couples the combustion engine 14 to the exhaust gas treatment system 12. The exhaust gas treatment system 12 may include one or more exhaust pipes 18 that transport engine exhaust gases along the exhaust gas treatment system 12 and to a tailpipe 20. The exhaust gas treatment system 12 may also include a TWC 22, and particulate filter, such as, for example, a DPF 100. According to certain embodiments, the exhaust treatment system 12 may also include a NOx particulate filter that has a Selective Catalytic Reduction system that further assists in the removal of NOx from the exhaust gas.

The combustion of fossil fuels in a combustion chamber of the combustion engine 14 produces exhaust gases that are delivered through an exhaust pipe 18 to the TWC 22. Catalytic formulations within the TWC 22 may then be used to reduce the levels of NOx, carbon monoxide, and un-burnt hydrocarbons in the exhaust gas. However, the exhaust gas exiting the TWC may still include certain levels of these pollutants, as well as other compounds, including NH₃ and/or particulate matter, such as soot. The exhaust gas may then exit the TWC 22 and flow through an exhaust pipe 18 to the DPF 100. The DPF 100 may be configured to perform a number of different functions, including oxidizing NH₃ in the exhaust gas, as well as removing the particulate matter from the exhaust gas. The exhaust gas may then flow or pass out of the DPF 100 and into the tailpipe 20, which may release the exhaust gas from the engine system 10.

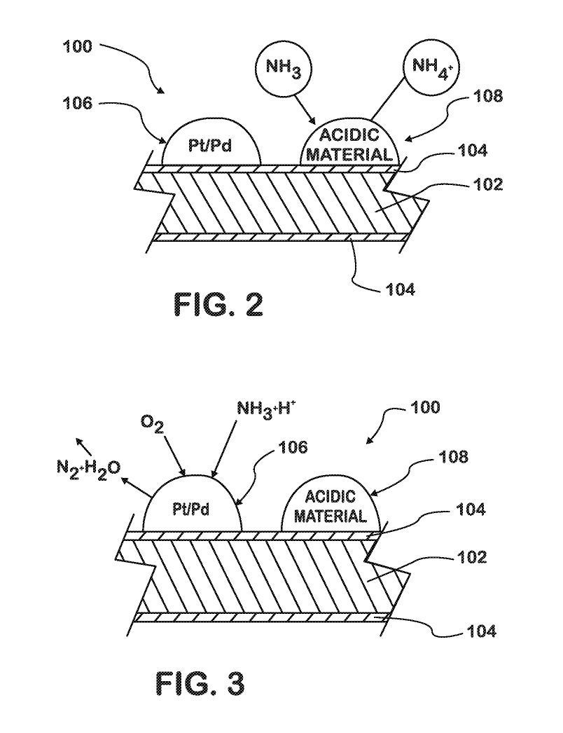

FIGS. 2 and 3 illustrate a cross sectional view of a portion of a DPF 100 that has a first surface 102 that has been washcoated with a washcoat formula that includes at least alumina to provide an alumina coating 104. The first surface 102 may be part of a larger structure within the DPF 100 that has also been washcoated to provide an alumina coating 104. The washcoat formula may also include platinum group metal, such as platinum (Pt) and/or palladium (Pd), which, with the alumina coating 104, provides a catalyst (Pt/Pd catalyst 106) that is used to oxidize at least a portion of the NH₃ that enters into the DPF 100, and thereby convert NH₃ to nitrogen (or nitrous oxide) gas and water.

The washcoat formula applied to the first surface 102 may also include relatively low amounts of an acidic material 108 that has adsorbent qualities that may be used to store excess NH₃. For example, the acidic material 108 may be a micro-porous material, including, for example, large or small pore zeolite materials or zirconium dioxide (ZrO₂) (also referred to as zirconia), among others. The selection of acidic material 108 for use in the DPF 100 may include not only the ability of the acidic material 108 to adsorb NH₃, but also the quantity of NH₃ that the acidic material 108 is generally able to store.

As previously discussed, during certain periods of engine operation, such as when exhaust gas is rich (or above the stoichiometric point (>1)), exhaust gas may be provided to the TWC 22 in a condition that results in the reductant formulations of the TWC 22 forming elevated, or spiked, levels of NH₃ in the exhaust gas. Exhaust gas with the elevated levels of NH₃ may then exit the TWC and flow to the DPF 100. However, due to the increased levels of NH₃ in the entering exhaust gas, the Pt/Pd catalyst 106 in the DPF 100 may be unable to oxidize a sufficient amount of the NH₃ that is present in the DPF 100, which may result in an undesirable amount of the NH₃ slipping out of the DPF 100. Yet, in such situations, the acidic material 108 may be used to at least temporarily trap and/or store at least a portion of the excess NH₃, and thereby prevent an undesirable amount of the excess NH₃ from slipping through the DPF 100.

For example, the use of a zeolite material as the acidic material 108 may allow for excess NH₃ to be adsorbed by the zeolite material as NH₄⁺ (after a proton transfer). NH₃ in the NH₄⁺ form may remain stored in the zeolite material at least until the NH₃ levels of the exhaust gas entering into, or in the DPF 100, return to, or are below, levels that the DPF 100 can effectively oxidize. When the exhaust gas is in such a net lean or oxidizing state in the DPF 100, NH₃ may be released from the zeolite, and at least a portion of the NH₃ may subsequently then be oxidized by the Pt/Pd catalyst 106. Moreover, by storing and later releasing the excess NH₃, the excess NH₃ may have a greater chance of being oxidized by the Pt/Pd catalyst 106 than may have been possible during the relatively brief period when elevated amounts of NH₃ from the rich exhaust gas were present in the DPF 100.

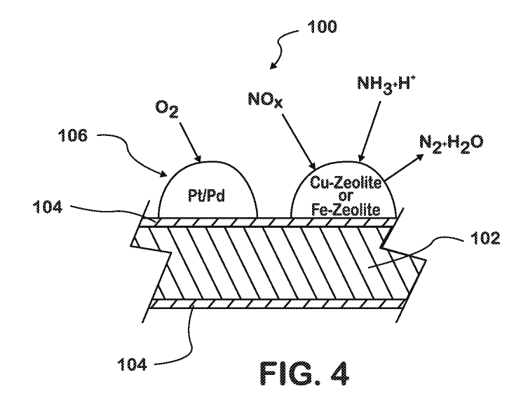

Referencing FIG. 4, according to certain embodiments, the acidic material 108 may also include an additive or element that, when the exhaust gas is in a lean condition, is used for the reduction of NOx to nitrogen (or nitrous oxide) gas and water. More specifically, the additive may provide a catalyst which is used along with the NH₃ that was previously adsorbed and by the acidic material 108 and stored therein as NH₄⁺ for the reduction of a portion of the NOx in the exhaust gas. According to certain embodiments in which the acidic material 108 is a zeolite, suitable additives include, but are not limited to, copper (Cu) or iron (Fe) elements, among other additives. Such metal-exchanged catalysts may be added to the zeolite through the use of ion exchange methods. Moreover, the inclusion of such additives in the acidic material 108 may provide at least some assistance to the NOx particulate filter (a DPF with a NOx reduction washcoat) in the exhaust treatment system 12 with the reduction of at least a portion of the NOx that is present in the exhaust gas before the exhaust gas is released from the tailpipe 20.

1. A diesel particulate filter for use in an exhaust gas treatment system to remove ammonia generated by a three-way catalytic converter during intermittent rich exhaust gas conditions (>1) comprising:
a catalyst having a platinum group metal and alumina, the catalyst configured to oxidize at least a portion of ammonia in an exhaust gas in the diesel particulate filter to form nitrogen (or nitrous oxide) gas and water; and
an acidic material configured to adsorb and store at least a portion of the ammonia from the exhaust gas that is present in the diesel particulate filter.

2. The diesel particulate filter of claim 1, wherein the acidic material includes an additive, the additive providing a catalyst for the reduction of NOx in the exhaust gas to nitrogen (or nitrous oxide) gas and water.

3. The diesel particulate filter of claim 2, wherein the acidic material is a zeolite.

4. The diesel particulate filter of claim 3, wherein the additive is a metal exchanged catalyst.

5. A diesel particulate filter for use in an exhaust gas treatment system comprising:
a catalyst configured to oxidize at least a portion of the ammonia in a rich exhaust gas in the diesel particulate filter to form nitrogen (or nitrous oxide) gas and water; and
an acidic material configured to adsorb and store at least a portion of the ammonia from the rich exhaust gas that is present in the diesel particulate filter, the acidic material further configured to release at least a portion of the adsorbed ammonia from the acidic material when a lean exhaust as is present in the diesel particulate filter.

6. The diesel particulate filter of claim 5, wherein the catalyst includes a platinum group metal and alumina.

7. The diesel particulate filter of claim 6, wherein the acidic material includes an additive, the additive providing a catalyst for the reduction of NOx in the exhaust gas to nitrogen (or nitrous oxide) gas and water.

8. The diesel particulate filter of claim 7, wherein the acidic material is a zeolite.

9. The diesel particulate filter of claim 8, wherein the additive is a metallic catalyst.

10. A diesel particulate filter for use in an exhaust gas treatment system comprising:
a catalyst configured to oxidize at least a portion of the ammonia that is present in a rich exhaust gas in the diesel particulate filter to form nitrogen (or nitrous oxide) gas and water;
an acidic material configured to adsorb and store at least a portion of the ammonia from the rich exhaust gas in the diesel particulate filter, the acidic material further configured to release at least a portion of the adsorbed ammonia from the acidic material when a lean exhaust as is present in the diesel particulate filter; and
an additive added to the acidic material, the additive providing a catalyst for the reduction of NOx in the lean exhaust gas to nitrogen (or nitrous oxide) gas and water.

11. The diesel particulate filter of claim 11, wherein the catalyst includes a platinum group metal and alumina.

12. The diesel particulate filter of claim 12, wherein the acidic material is a zeolite.

13. A method for the abatement of ammonia for a diesel engine exhaust system having a three-way catalytic converter and diesel particulate filter comprising:
delivering a first exhaust gas from a combustion chamber of an internal combustion engine to the housing of the three-way catalytic converter, the first exhaust gas being above the stoichiometric point (>1);
converting, in the three-way catalytic converter, nitrogen oxides in the first exhaust gas to nitrogen (or nitrous oxide) gas and oxygen to from a second exhaust gas, the conversion of the nitrogen oxides producing an elevated amount of ammonia in the outlet exhaust second exhaust gas;
delivering the second exhaust gas to the diesel particulate filter;
oxidizing, in the diesel particulate filter, at least a portion of the ammonia in the second exhaust gas using an oxygen gas and a catalyst having at least one platinum group metal and alumina; and
adsorbing, in an acidic material, in the diesel particulate filter at least a portion of the ammonia in the second exhaust gas that has not been oxidized.

14. The method of claim 13 further including the steps of releasing from the acidic material at least a portion of the adsorbed ammonia; and, oxidizing, in the diesel particulate filter, at least a portion of the released ammonia.

15. The method of claim 14 further including the step of converting, in the diesel particulate filter, NOx in an exhaust gas using a metal exchanged additive of the acidic material and ammonia that was adsorbed by the acidic material.
